(19) United States
(12) Patent Application Publication
(10) Pub. No.: US 2018/0309107 A1
(43) Pub. Date: Oct. 25, 2018

(54) INSULATION BARRIER FOR ELECTROCHEMICAL BATTERY AND ELECTROCHEMICAL BATTERY INCLUDING SAME

(71) Applicant: Unifrax I LLC, Tonawanda, NY (US)

(72) Inventor: Melissa WIDENER, North Tonawanda, NY (US)

(21) Appl. No.: 15/957,315

(22) Filed: Apr. 19, 2018

Related U.S. Application Data
(60) Provisional application No. 62/487,446, filed on Apr. 19, 2017.

(51) Int. Cl. H01M 2/16; H01M 10/0525; H01M 2/10; B60L 11/18; B60K 1/04

(52) U.S. Cl. CPC H01M 2/1666; H01M 2/1646; H01M 2/166; H01M 10/0525; B60Y 2410/114; B60L 11/1879; B60K 1/04; H01M 2220/20; B60K 2001/0438; H01M 2/1077

(57) ABSTRACT

An inorganic platelet composition for use as thermal and/or electrical insulation and fire protection for electrochemical cells such as lithium ion cells. The inorganic platelet composition may be located on individual battery cells, within the interstitial spaces of adjacent battery cells and/or between modules of battery cells in a larger battery pack. The inorganic platelet composition prevents thermal runaway that may occur in one cell or modules of cells from propagating to adjacent or nearby cells or modules within the battery pack.

The application claims the benefit of the filing date under 35 U.S.C. § 199(e) from U.S. Provisional Application for Patent Ser. No. 62/487,446, filed on Apr. 19, 2017.

The present disclosure relates to a thermal insulation and/or electrical insulation and fire protection material for electrochemical battery cells, modules and packs, and electrochemical battery modules and packs including the thermal and/or electrical insulation and fire protection material. For simplicity, the terms “thermal insulation” and “electrical insulation” as used herein are intended to include within their respective meanings both thermal and electrical insulating functionality, unless context dictates otherwise.

Lithium ion batteries are widely used to provide power to electric or hybrid vehicles (such as automobiles, buses, trucks, motorcycles, motorized bicycles, etc.), aircraft, marine craft, power tools, energy storage systems (such as uninterruptable power supplies, stationary storage systems, and/or for electric grid back-up applications), and portable electronic devices such as lap top, notebook and tablet computers, cellular telephones, smart telephones, digital cameras, digital camcorders, handheld gaming devices, MP3 players, PDAs, iPods, flashlights and like electronic devices.

A lithium ion battery includes an outer metal housing. Enclosed within the outer metal housing are a cathode (ie, positive electrode), an anode (ie, negative electrode) and a separator. In a typical cylindrical lithium ion battery, the cathode, anode and separator are provided in the form of long spiral rolls of thin sheets. The cathode, anode and separator sheets are submerged in a solvent that acts as an electrolyte. The separator separates the anode and cathode while permitting lithium ions to pass through it.

In a typical lithium ion cell the cathode may be made from lithium cobalt oxide (LiCoO₂), lithium iron phosphate (LiFePO₄), lithium titanium oxide (Li₂TiO₃), nickel manganese cobalt, nickel cobalt aluminum, or lithium manganese oxide (LiMn₂O₄). The anode may be made of carbon (such as graphite), or lithium titanium oxide (Li₄Ti₅O₁₂ (such as in aerogel form)). During the charging process, in certain embodiments, when the lithium ion cell is absorbing power, lithium ions move through the electrolyte from the cathode to the anode and attached to the carbon. During the discharging process, in certain embodiments, when the lithium ion cell is giving out power, the lithium ions move back through the electrolyte from the carbon anode to the lithium cathode.

Lithium ion battery packs may be comprised of one to thousands of lithium ion cells. Large lithium ion batteries may comprise individual modules or cells that are organized in series or parallel. The lithium ion cell is the smallest, packaged unit a lithium ion battery can take. A module comprises several individual lithium ion cells that are electrically connected in series or parallel. A lithium ion battery pack may be assembled by electrically connecting a plurality of lithium in modules together in series or parallel.

Lithium in cells are susceptible to “thermal runaway.” The term “thermal runaway” refers to a rapid uncontrolled increase in temperature. The electrolyte contained within the lithium ion call may be highly flammable. In the event that the cell or module experiences a “thermal runaway” condition, the electrolyte contained within the cells may ignite causing an explosion and fire.

What is needed in the art is improved materials that mitigate thermal runaway propagation and electrical short circuits in electrochemical battery modules and packs such as lithium ion battery modules and packs, prevent cascading fires within battery modules and packs, and provide thermal insulation and containment, electrical insulation and fire prevention, within battery packs and modules.

Provided is an electrochemical battery module comprising a housing having an interior surface and an exterior surface, at least one electrochemical battery cell positioned within said housing, and one or more of the following:
(i) an inorganic platelet composition positioned adjacent to or on at least a portion of said interior surface of said housing;
(ii) an inorganic platelet composition positioned adjacent to or on at least a portion of said exterior surface of said housing;
(iii) wherein said electrochemical battery module comprises a plurality of said electrochemical battery cells, and wherein an inorganic platelet composition is on said electrochemical battery cells; or
(iv) wherein said electrochemical battery module comprises a plurality of said electrochemical battery cells having interstitial spaces between said plurality of said electrochemical battery cells, and wherein an inorganic platelet composition is located within at least a portion of said interstitial spaces between said electrochemical battery cells.

It should be noted that the electrochemical battery module or pack need not include each of features (i), (ii), (iii), or (iv) described hereinabove. The electrochemical battery module or pack need only include one of features (i), (ii), (iii), or (iv) described hereinabove. According to certain embodiments, the electrochemical battery pack may include a combination of more than one of feature selected from features (i), (ii), (iii), or (iv) described hereinabove. According to certain illustrative embodiments, the electrochemical battery pack may include a combination of two features selected from features (i), (ii), (iii), and (iv) described hereinabove. According to certain illustrative embodiments, the electrochemical battery pack may include a combination of three features selected from features (i), (ii), (iii), and (iv) described hereinabove. According to certain illustrative embodiments, the electrochemical battery pack may include a combination of all four features (i), (ii), (iii), and (iv) described hereinabove.

According to certain illustrative embodiments, the electrochemical battery module comprises a housing having an interior surface and an exterior surface, at least one electrochemical battery cell positioned within said housing, and an inorganic platelet composition positioned adjacent to or on at least a portion of said interior surface of said housing.

According to certain illustrative embodiments, the electrochemical battery module comprises a housing having an interior surface and an exterior surface, at least one electrochemical battery cell positioned within said housing, and an inorganic platelet composition positioned adjacent to or on at least a portion of said exterior surface of said housing.

According to certain illustrative embodiments, the electrochemical battery module comprises a housing having an interior surface and an exterior surface, a plurality of electrochemical battery cells positioned within said housing, and an inorganic platelet composition applied to, located on, or positioned on, at least one of said electrochemical battery cells.

According to certain illustrative embodiments, the electrochemical battery module comprises a housing having an interior surface and an exterior surface, a plurality of said electrochemical battery cells positioned within said housing having interstitial spaces between the plurality of said electrochemical battery cells, and an inorganic platelet composition located or positioned within at least a portion of said interstitial spaces between said electrochemical battery cells.

According to certain illustrative embodiments, the electrochemical battery module comprises a housing having an interior surface and an exterior surface, a plurality of said electrochemical battery cells positioned within said housing having interstitial spaces between the plurality of said electrochemical battery cells, and an inorganic platelet composition located or positioned adjacent or on at least a portion of said interior surface of said housing and within at least a portion of said interstitial spaces between said electrochemical battery cells.

According to certain illustrative embodiments, the electrochemical battery module comprises a plurality of individual electrochemical battery cells electrically connected together, said electrochemical module comprising interstitial spaces between the individual electrochemical battery cells, and an inorganic platelet composition located or positioned on at least a portion of said electrochemical battery cells and within at least a portion of said interstitial spaces between said individual electrochemical battery cells of said electrochemical battery module.

According to certain illustrative embodiments, the electrochemical battery pack comprises a housing having an interior surface and an exterior surface, at least one electrochemical battery cell positioned within said housing, and an inorganic platelet composition positioned adjacent to or on at least a portion of said interior surface of said housing.

According to certain illustrative embodiments, the electrochemical battery pack comprises a housing having an interior surface and an exterior surface, at least one electrochemical battery cell positioned within said housing, and an inorganic platelet composition positioned adjacent to or on at least a portion of said exterior surface of said housing.

According to certain illustrative embodiments, the electrochemical battery pack comprises a housing having an interior surface and an exterior surface, a plurality of electrochemical battery cells positioned within said housing, and an inorganic platelet composition applied to, located on, or positioned on, at least one of said electrochemical battery cells.

According to certain illustrative embodiments, the electrochemical battery pack comprises a housing having an interior surface and an exterior surface, a plurality of said electrochemical battery cells positioned within said housing having interstitial spaces between the plurality of said electrochemical battery cells, and an inorganic platelet composition located or positioned within at least a portion of said interstitial spaces between said electrochemical battery cells.

According to certain illustrative embodiments, the electrochemical battery pack comprises a housing having an interior surface and an exterior surface, a plurality of said electrochemical battery cells positioned within said housing having interstitial spaces between the plurality of said electrochemical battery cells, and an inorganic platelet composition located or positioned adjacent or on at least a portion of said interior surface of said housing and within at least a portion of said interstitial spaces between said electrochemical battery cells.

According to certain illustrative embodiments, the electrochemical battery pack comprises a plurality of individual electrochemical battery cells electrically connected together, said electrochemical pack comprising interstitial spaces between the individual electrochemical battery cells, and an inorganic platelet composition located or positioned on at least a portion of said electrochemical battery cells and within at least a portion of said interstitial spaces between said individual electrochemical battery cells of said electrochemical battery pack.

Further provided is a method for minimizing the propagation of thermal runaway within an electrochemical battery module comprising a housing having interior surfaces and exterior surfaces and a plurality of individual electrochemical battery cells electrically connected together and positioned within said housing, and having interstitial spaces between the individual electrochemical battery cells, the method comprising locating inorganic platelet composition (i) located or positioned on the exterior surfaces of at least a portion of the individual electrochemical cells positioned within said housing, and/or (ii) within at least a portion of said interstitial spaces between said individual electrochemical battery cells positioned within said housing of said electrochemical battery module, and/or (iii) adjacent to or on at least a portion of the internal surfaces of the housing of the electrochemical battery module, and/or (iv) adjacent to or on at least a portion of the external surfaces of the hosing of the electrochemical battery module.

Further provided is a method for minimizing the propagation of thermal runaway within an electrochemical battery pack comprising a housing having interior surfaces and exterior surfaces and a plurality of individual electrochemical battery cells electrically connected together and positioned within said housing, and having interstitial spaces between the individual electrochemical battery cells, the method comprising locating inorganic platelet composition (i) located or positioned on the exterior surfaces of at least a portion of the individual electrochemical cells positioned within said housing, and/or (ii) within at least a portion of said interstitial spaces between said individual electrochemical battery cells positioned within said housing of said electrochemical battery pack, and/or (iii) adjacent to or on at least a portion of the internal surfaces of the housing of the electrochemical battery pack, and/or (iv) adjacent to or on at least a portion of the external surfaces of the housing of the electrochemical battery pack.

Further provided is an electric vehicle or hybrid electric vehicle comprising a structural frame, a passenger cabin, an electric drive motor, a motor controller, braking system, and electrochemical battery pack, said electrochemical battery pack comprising a plurality of individual battery cells electrically connected together and having interstitial spaces between the individual battery cells, inorganic platelet composition (i) located or positioned on the exterior surfaces of at least a portion of the individual electrochemical cells positioned within said housing, and/or (ii) within at least a portion of said interstitial spaces between said individual electrochemical battery cells positioned within said housing of said electrochemical battery pack, and/or (iii) adjacent to or on at least a portion of the internal surfaces of the housing of the electrochemical battery pack, and/or (iv) adjacent to or on at least a portion of the external surfaces of the housing of the electrochemical battery pack.

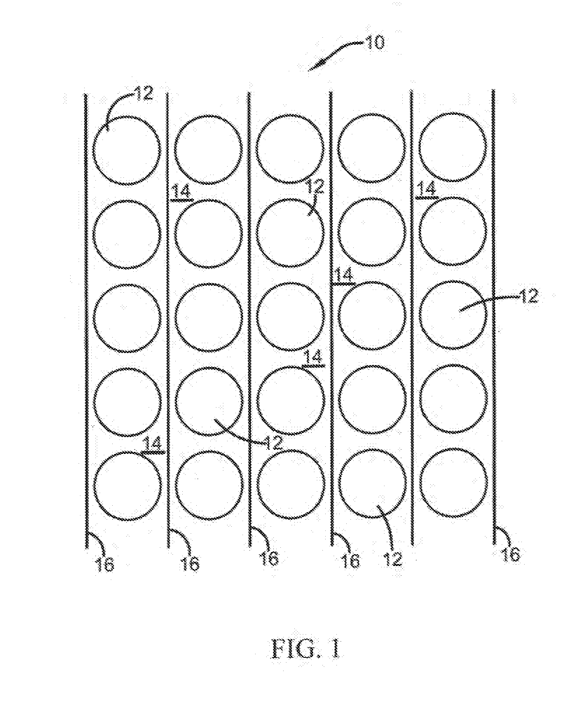

FIG. 1 depicts a first illustrative embodiment of a battery pack including a thermal/electrical insulation barrier.

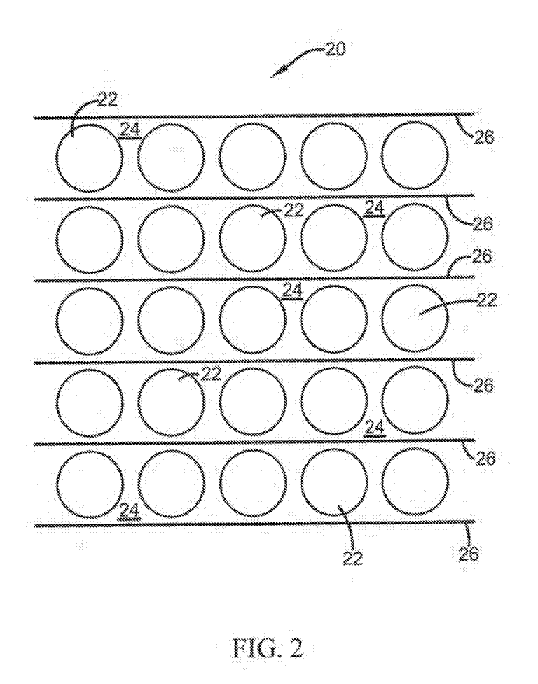

FIG. 2 depicts a second illustrative embodiment of a battery pack including a thermal/electrical insulation barrier.

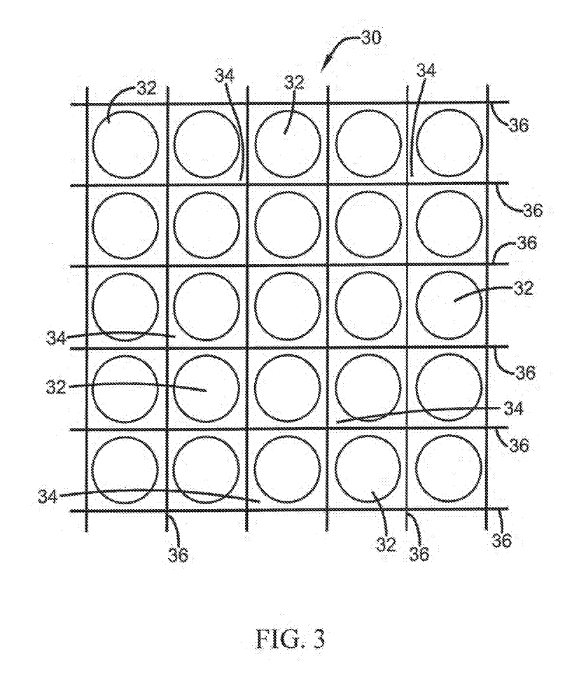

FIG. 3 depicts a third illustrative embodiment of a battery pack including a thermal/electrical insulation barrier.

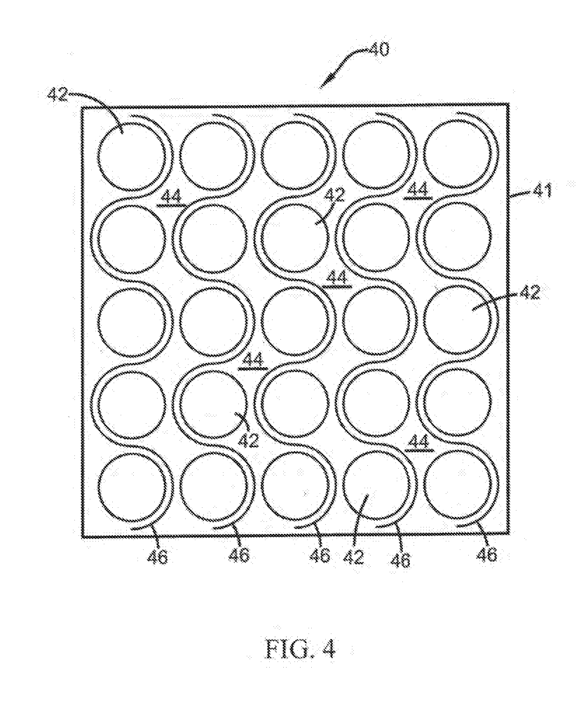

FIG. 4 depicts a fourth illustrative embodiment of a battery pack including a thermal/electrical insulation barrier.

The inorganic platelet based thermal and electrical insulating composition mitigates the propagation of thermal runaway for an electrochemical battery module or battery pack containing a plurality of individual electrochemical battery cells by mitigating the effects of one or more individual battery cells undergoing a thermal runaway event, thereby preventing the propagation of the thermal runaway event to neighboring cells or modules within the battery pack.

As shown in FIG. 1, an illustrative electrochemical battery module (or battery pack) 10 comprises a plurality or individual electrochemical battery cells 12, said electrochemical module comprising interstitial spaces 14 between the individual electrochemical battery cells 12, and an inorganic platelet composition 16, such as a coating, composite, or laminate, located within said interstitial spaces 14.

As shown in FIG. 2, an illustrative electrochemical battery module (or battery pack) 20 comprises a plurality of individual electrochemical battery cells 22, said electrochemical module comprising interstitial spaces 24 between the individual electrochemical battery cells 22, and an inorganic platelet composition 26, such as a coating, composite, or laminate, located within said interstitial spaces 24.

As shown in FIG. 3, an illustrative electrochemical battery module (or battery pack) 30 comprises a plurality of individual electrochemical battery cells 32, said electrochemical module comprising interstitial spaces 34 between the individual electrochemical battery cells 32, and an inorganic platelet composition 36, such as a coating, composite, or laminate, located within said interstitial spaces 34.

As shown in FIG. 4, an illustrative electrochemical battery module (or battery pack) 40 comprises a plurality of individual electrochemical battery cells 42, said electrochemical module comprising interstitial spaces 44 between the individual electrochemical battery cells 42, and an inorganic platelet composition 46, such as a coating, composite or laminate, located within said interstitial spaces 44.

According to certain embodiments, a battery pack is provided that includes an insulation barrier having thermal and electrical insulation and fire protective properties that is, or is based on, an inorganic platelet composition isolating individual cells or dividing individual cells within the battery pack into individual cells or smaller groups of cells. The thermal and electrical insulation barrier separates the battery cells into individual cells or smaller groups to prevent a thermal runaway event initiated in an individual cell or within a group of cells from propagating to the cells within a neighboring cells or group of cells.

According to certain embodiments, a battery pack is provided that includes an insulation barrier having thermal and electrical insulation and fire protective properties that is, or is based on, an inorganic platelet composition, wherein the inorganic platelet composition is included in at least one of the following portions of the battery pack: (i) at least a portion of the interior surface of a housing of the battery pack; (ii) at least a portion of the exterior surface of a housing of the battery pack; (iii) at least a portion of the interstitial spaces between a plurality of cells in the battery pack, or (iv) on the exterior housing surface of the individual electrochemical battery cells. The inorganic platelet composition may be provided as a coating, as a distinct layer, a sheet material, a paper material, a felt material, a composite and/or laminate material, or a wide variety of three dimensional vacuum formed shapes.

As used throughout the present specification, the terms “battery”, “cell”, “battery cell”, or “electrochemical cell” may be used interchangeably and may refer to any of a variety of different cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery types/configurations.

As used throughout the present specification, the term “battery pack” as used herein refers to multiple individual battery cells partially or fully contained within a suitable housing, the individual battery cells being electrically interconnected to achieve the desired voltage and capacity for a particular application.

As used throughout the present specification, the term “electric vehicle” as used herein may refer to an all-electric vehicle, also referred to as an EV, a plug-in hybrid vehicle, also referred to as a PHEV, or a hybrid vehicle, also referred to as a HEV, where a hybrid vehicle refers to a vehicle utilizing multiple propulsion sources one of which is an electric drive system.

The inorganic platelets of the inorganic platelet composition may be selected from vermiculite platelets, mica platelets, clay platelets, talc platelets and combinations thereof.

According to certain embodiments, the inorganic platelets comprise vermiculite platelets. According to certain embodiments, the inorganic platelets comprise mica platelets. According to certain embodiments, the inorganic platelets comprise clay platelets. According to certain embodiments, the inorganic platelets comprise a blend of vermiculite and mica platelets.

The inorganic platelet composition may comprise coated platelets. Without limitation, and only by way of illustration, the inorganic platelets may be at least partially coated with a coating selected form, such as, for example, titanium dioxide, iron oxide, chromium oxide, tin oxide, silicon oxide, cobalt oxide, antimony oxide and combinations thereof. According to certain illustrative embodiments, the exterior surfaces of the inorganic platelets are partially coated with a coating. According to other illustrative embodiments, the exterior surfaces of the inorganic platelets are substantially coating with a coating. According to yet other illustrative embodiments, the exterior surfaces of the inorganic platelets are entirely coated with a coating.

The inorganic platelets, such as the vermiculite or mica platelets, that may be used to prepare the inorganic platelet composition may be exfoliated. By exfoliated or exfoliation, it is meant that the vermiculite or mica platelets are chemically or thermally expanded. According to other illustrative embodiments, the vermiculite or mica platelets may be exfoliated and defoliated. By defoliated or defoliation, its is meant that the exfoliated vermiculite or mica platelets are further processed in order to reduce the vermiculite or mica to substantially a desired platelet form.

Without limitation, and only by way of illustration, suitable mica platelets that may be used as the inorganic platelets in the inorganic platelet composition include muscovite, phlogopite, biotite, lepidolite, glauconite, paragonite and zinnwaldite, and synthetic micas such as fluorophlogopite. According to certain embodiments, the mica platelets comprise muscovite mica platelets. According to other embodiments, the mica platelets comprise phlogopite mica platelets.

With limitation, and only by way of illustration, suitable platelet clay material that may be used as the inorganic platelets may include, without limitation, ball clay, bentonite, smectite, hectorite, kaolinite, montmorillonite, saponite, sepiolite, sauconite, or combination thereof.

While any size inorganic platelet material may be used to prepare a thermal and electrical barrier comprising an inorganic platelet composition, inorganic platelets with larger relative diameters and high diameter to thickness aspect ratios may be desirable due to their gas impermeability, as well as other properties such as flexibility and processibility. In certain illustrative embodiments, the inorganic platelets may have a diameter of from about 20 μm to about 300 μm. In further embodiments, the inorganic platelets may have a diameter of from about 40 μm to about 200 μm. In certain embodiments, the inorganic platelets may have an aspect ratio of from about 50:1 to about 2000:1. In certain embodiments, the inorganic platelets may have an aspect ratio of from about 50:1 to about 1000:1. In further embodiments, the inorganic platelets may have an aspect ratio of from about 200:1 to about 800:1.

the inorganic platelet composition may comprise inorganic platelets in an amount from about 20 to about 100 weight percent, based on the total weight of the inorganic platelet composition. The inorganic platelet composition may comprise inorganic platelets in an amount of least about 20 weight percent, based on the total weight of the inorganic platelet composition. The inorganic platelet composition may comprise inorganic platelets in an amount of least about 30 weight percent, based on the total weight of the inorganic platelet composition. The inorganic platelet composition may comprise inorganic platelets in an amount of least about 40 weight percent, based on the total weight of the inorganic platelet composition. The inorganic platelet composition may comprise inorganic platelets in an amount of least about 50 weight percent, based on the total weight of the inorganic platelet composition. The inorganic platelet composition may comprise inorganic platelets in an amount of least about 60 weight percent, based on the total weight of the inorganic platelet composition. The inorganic platelet composition may comprise inorganic platelets in an amount of least about 70 weight percent, based on the total weight of the inorganic platelet composition. The inorganic platelet composition may comprise inorganic platelets in an amount of least about 80 weight percent, based on the total weight of the inorganic platelet composition. The inorganic platelet composition may comprise inorganic platelets in an amount of least about 86 weight percent, based on the total weight of the inorganic platelet composition. The inorganic platelet composition may comprise inorganic platelets in an amount of least about 90 weight percent, based on the total weight of the inorganic platelet composition. The inorganic platelet composition may comprise inorganic platelets in an amount of least about 95 weight percent, based on the total weight of the inorganic platelet composition. The inorganic platelet composition may comprise inorganic platelets in an amount of least about 99 weight percent, based on the total weight of the inorganic platelet composition. The inorganic platelet layer of the inflation gas deflector composite may comprise platelets in an amount of 100 weight percent.

The inorganic platelet composition may comprise mica platelets in an amount of least about 20 weight percent, based on the total weight of the inorganic platelet composition. The inorganic platelet composition may comprise mica platelets in an amount of least about 30 weight percent, based on the total weight of the inorganic platelet composition. The inorganic platelet composition may comprise mica platelets in an amount of least about 40 weight percent, based on the total weight of the inorganic platelet composition. The inorganic platelet composition may comprise mica platelets in an amount of least about 50 weight percent, based on the total weight of the inorganic platelet composition. The inorganic platelet composition may comprise mica platelets in an amount of least about 60 weight percent, based on the total weight of the inorganic platelet composition. The inorganic platelet composition may comprise mica platelets in an amount of least about 70 weight percent, based on the total weight of the inorganic platelet composition. The inorganic platelet composition may comprise mica platelets in an amount of least about 80 weight percent, based on the total weight of the inorganic platelet composition. The inorganic platelet composition may comprise mica platelets in an amount of least about 85 weight percent, based on the total weight of the inorganic platelet composition. The inorganic platelet composition may comprise mica platelets in amount of least about 90 weight percent, based on the total weight of the inorganic platelet composition. The inorganic platelet composition may comprise mica platelets in an amount of least about 95 weight percent, based on the total weight of the inorganic platelet composition. The inorganic platelet composition may comprise mica platelets in an amount of least about 99 weight percent, based on the total weight of the inorganic platelet composition. The inorganic platelet composition may comprise mica platelets in an amount of least about 100 weight percent, based on the total weight of the inorganic platelet composition.

The inorganic platelet composition may comprise vermiculite platelets in an amount of least about 20 weight percent, based on the total weight of the inorganic platelet composition. The inorganic platelet composition may comprise vermiculite platelets in an amount of least about 30 weight percent, based on the total weight of the inorganic platelet composition. The inorganic platelet composition may comprise vermiculite platelets in an amount of least about 40 weight percent, based on the total weight of the inorganic platelet composition. The inorganic platelet composition may comprise vermiculite platelets in an amount of least about 50 weight percent, based on the total weight of the inorganic platelet composition. The inorganic platelet composition may comprise vermiculite platelets in an amount of least about 60 weight percent, based on the total weight of the inorganic platelet composition. The inorganic platelet composition may comprise vermiculite platelets in an amount of least about 70 weight percent, based on the total weight of the inorganic platelet composition. The inorganic platelet composition may comprise vermiculite platelets in an amount of least about 80 weight percent, based on the total weight of the inorganic platelet composition. The inorganic platelet composition may comprise vermiculite platelets in an amount of least about 85 weight percent, based on the total weight of the inorganic platelet composition. The inorganic platelet composition may comprise vermiculite platelets in an amount of least about 90 weight percent, based on the total weight of the inorganic platelet composition. The inorganic platelet composition may comprise vermiculite platelets in an amount of least about 95 weight percent, based on the total weight of the inorganic platelet composition. The inorganic platelet composition may comprise vermiculite platelets in an amount of least about 99 weight percent, based on the total weight of the inorganic platelet composition. The inorganic platelet composition may comprise vermiculite platelets in an amount of least about 100 weight percent, based on the total weight of the inorganic platelet composition.

The inorganic platelet composition may comprise a blend of mica and vermiculite platelets in an amount of least about 20 weight percent, based on the total weight of the inorganic platelet composition. The inorganic platelet composition may comprise a blend of mica and vermiculite platelets in an amount of least about 30 weight percent, based on the total weight of the inorganic platelet composition. The inorganic platelet composition may comprise a blend of mica and vermiculite platelets in an amount of least about 40 weight percent, based on the total weight of the inorganic platelet composition. The inorganic platelet composition may comprise a blend of mica and vermiculite platelets in an amount of least about 50 weight percent, based on the total weight of the inorganic platelet composition. The inorganic platelet composition may comprise a bland of mica and vermiculite platelets in an amount of least about 60 weight percent, based on the total weight of the inorganic platelet composition. The inorganic platelet composition may comprise a blend of mica and vermiculite platelets in an amount of least about 70 weight percent, based on the total weight of the inorganic platelet composition. The inorganic platelet composition may comprise a blend of mica and vermiculite platelets in an amount of least about 80 weight percent, based on the total weight of the inorganic platelet composition. The inorganic platelet composition may comprise a blend of mica and vermiculite platelets in an amount of least about 85 weight percent, based on the total weight of the inorganic platelet composition. The inorganic platelet composition may comprise a blend of mica and vermiculite platelets in an amount of least about 90 weight percent, based on the total weight of the inorganic platelet composition. The inorganic platelet composition may comprise a blend of mica and vermiculite platelets in an amount of least about 95 weight percent, based on the total weight of the inorganic platelet composition. The inorganic platelet composition may comprise a blend of mica and vermiculite platelets in an amount of least about 99 weight percent, based on the total weight of the inorganic platelet composition. The inorganic platelet composition may comprise a blend of mica and vermiculite platelets in an amount of least about 100 weight percent, based on the total weight of the inorganic platelet composition.

In certain embodiments, the inorganic platelet composition may comprise from about 20 to less than about 100 percent by weight of inorganic platelets and from greater than 0 to about 80 percent by weight of binder, based on the total weight of the inorganic platelet composition. In certain embodiments, the inorganic platelet composition may comprise from about 30 to less than about 100 percent by weight of inorganic platelets and from greater than 0 to about 70 percent by weight of binder, based on the total weight of the inorganic platelet composition. In certain embodiments, the inorganic platelet composition may comprise from about 40 to less than about 100 percent by weight of inorganic platelets and from greater than 0 to about 60 percent by weight of binder, based on the total weight of the inorganic platelet composition. In certain embodiments, the inorganic platelet composition may comprise from about 50 to less than about 100 percent by weight of inorganic platelets and from greater than 0 to about 50 percent by weight of binder, based on the total weight of the inorganic platelet composition. In certain embodiments, the inorganic platelet composition may comprise from about 60 to less than about 100 percent by weight of inorganic platelets and from greater than 0 to about 40 percent by weight of binder, based on the total weight of the inorganic platelet composition. In certain embodiments, the inorganic platelet composition may comprise from about 70 to less than about 100 percent by weight of inorganic platelets and from greater than 0 to about 30 percent by weight of binder, based on the total weight of the inorganic platelet composition. In certain embodiments, the inorganic platelet composition may comprise from about 80 to less than about 100 percent by weight of inorganic platelets and from greater than 0 to about 20 percent by weight of binder, based on the total weight of the inorganic platelet composition.

In certain embodiments, the inorganic platelet composition may comprise from about 20 to less than about 100 percent by weight of inorganic platelets, from greater 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of inorganic platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said inorganic platelets, from greater than 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to less than about 100 percent by weight of mica platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of mica platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said mica platelets, from greater than 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to less than about 100 percent by weight of vermiculite platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of vermiculite platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said vermiculite platelets, from greater 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to less than about 100 percent by weight of a blend of mica and vermiculite platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weigh of a blend mica and vermiculite platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said a blind of mica and vermiculite platelets, from greater than 0 to about 20 percent by weight of a binder, and from greater than 0 to about 20 percent by weight of a functional filler, based on the total weight of the inorganic platelet composition.

All of the embodiments of the inorganic platelet composition described may include an organic binder and/or inorganic binder in addition to the inorganic platelets. The binder may include a blend of more than one type of organic binder and one type of inorganic binder. The binder may include one type of organic binder and more than one type of inorganic binder. The binder may include a blend of more than one type of organic binder and more than one type of inorganic binder.

The organic binder may comprise a signal type of organic binder or a blend of more than one type of organic binder. The organic binder(s) may be provided as a solid, a liquid, a solution, a dispersion, a latex, or similar form. Examples of suitable organic binders that may be included in the inorganic platelet composition include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organic silicones, organofunctional silanes, unsaturated polyesters, epoxy resins, polyvinyl esters (such as polyvinylacetate or polyvinylbutyrate latexes) and the like. According to certain embodiments, the organic binder included in the inorganic platelet composition comprises a silicone binder. According to certain embodiments, the organic binder included in the inorganic platelet composition comprises an unsaturated polyester binder.

The inorganic binder may comprise a single type of inorganic binder or a blend of more than one type of inorganic binder. Without limitation, suitable inorganic binders that may be included in inorganic platelet composition are selected from colloidal alumina, colloidal silica, colloidal zirconia, and mixtures thereof.

The inorganic platelet composition may include mica platelets and an inorganic binder. The inorganic binder may comprise a single type of inorganic binder or a blend of more than one type of inorganic binder. Without limitation, suitable inorganic binders that may be included in inorganic platelet composition may include colloidal alumina, colloidal silica, colloidal zirconia, and mixtures thereof.

The inorganic platelet composition may include vermiculite platelets and an inorganic binder. The inorganic binder may comprise a single type of inorganic binder or a blend of more than one type of inorganic binder. Without limitation, suitable inorganic binders that may be included in inorganic platelet composition are selected from colloidal alumina, colloidal silica, colloidal zirconia, and mixtures thereof.

The inorganic platelet composition may include a blend of mica and vermiculite platelets and an inorganic binder. The inorganic binder may comprise a single type of inorganic binder or a blend of more than one type of inorganic binder. Without limitation, suitable inorganic binders that may be included in inorganic platelet composition include colloidal alumina, colloidal silica, colloidal zirconia, and mixtures thereof.

The inorganic platelet composition may include mica platelets and at least one organic binder. The inorganic platelet composition may include vermiculite platelets and at least one organic binder. The inorganic platelet composition may include a blend of mica and vermiculite platelets and at least one organic binder.

For illustrative embodiments where the inorganic platelets are carried on a support layer, the inorganic platelets may be added to the support layer in an amount of about 25 gsm to about 500 gsm. According to certain embodiments, the inorganic platelets may be added to the support layer in an amount of about 30 gsm to about 400 gsm. According to other embodiments, the inorganic platelets may be added to the support layer in an amount of about 40 gsm to about 300 gsm.

The one or more support layer(s) of the thermal and electrical insulation barrier may comprise a polymer film, a paper, a woven fabric, a non-woven fabric or combinations thereof. The inorganic platelet composition (such as one or more inorganic platelet layer(s)) may be adhered to the support layer through a suitable amount of adhesive positioned between the support layer and inorganic platelets. According to certain embodiments the inorganic platelet composition, such as one or more layers of the inorganic platelet composition, may be adhered to the underlying support layer by one or more layer(s) of adhesive. The layer of adhesive may be a continuous or discontinuous layer.

The thermal and/or electrical insulation barrier may comprise a multiple layer composite comprising a support layer, an adhesive layer applied to a major surface of the support layer, and an inorganic platelet composition or layer applied to the adhesive layer. The inorganic platelet layer may be supplied as a fluid coating composition that is coated onto a major surface of the adhesive layer. Alternatively, the inorganic platelet layer may be first formed into a film, paper, or sheet, and then the sheet of inorganic platelet composition is joined to the support layer with the adhesive layer being positioned between these two layers to bond the inorganic platelet sheet to the support layer. The film, paper, sheet of the inorganic platelet composition may be joined to the support layer by any suitable joining process, such as a lamination process. The lamination process may be a heated lamination process to soften the materials to join them together with an adhesive bond.

The multiple layer composite may further include a reinforcing layer. According to certain embodiments, the reinforcing layer may comprise an open weave reinforcing scrim. The reinforcing scrim may be placed adjacent the major surface of the support layer, may be embedded into the adhesive layer, may be embedded into the inorganic platelet layer, or any combination of one or more of these. The open weave reinforcing scrim layer may comprise reinforcing fibers such as carbon fibers, glass fibers, high strength polymer fibers, or combinations thereof.

According to certain illustrative embodiments, the one or more support layer(s) comprises a polymer film. The polymer film may be selected from polyester, polyimide, polyetherketone, polyetheretherketone, polyvinylfluoride, polyamide, polyeterafluorethylene, polyaryl sulfone, polyester amide, polyester imide, polyethersulfone, polyphenylene sulfide, ethylene chlorotrifluoroethylene films and combinations thereof. According to certain embodiments, the polymer film comprises a polyetheretherketone film.

According to other illustrative embodiments, the one or more support layers(s) comprises a paper. The paper comprising the support layer may comprise an inorganic fiber paper, such as a paper containing inorganic fibers and binder. The inorganic fibers may be selected from high alumina polycrystalline fibers, mullite fibers, ceramic fibers, glass fibers, biosoluble fibers, quartz fibers, silica fibers and combinations thereof. The fiber paper may be an organic fiber paper comprising polymer fibers selected from, for example, polyolefin fibers, polyester fibers, polyamide fibers and combinations thereof.

Any heat resistant inorganic fibers may be used to prepare the sheet or paper so long as the inorganic fibers can withstand the forming process, and can support the inorganic platelet composition layer(s) and optional adhesive layer(s). Without limitation, and only by way of illustration, suitable inorganic fibers that may be used to prepare the paper or sheet include high alumina polycrystalline would fibers, refractory ceramic fibers such as alumina-silica fibers, alumina-magnesia-silica fibers, kaolin fibers, alkaline earth silicate fibers such as calcia-magnesia-silica fibers and magnesia-silica fibers, S-glass fibers, S2-glass fibers, E-glass fibers, quartz fibers, silica fibers and combinations of one or more of these types of inorganic fibers.

According to certain embodiments, the heat resistant inorganic fibers that are used to prepare the support layer for the inorganic platelets. Without limitation, and only by way of illustration, suitable refractory ceramic fibers include alumina fibers, alumina-silica fibers, alumina-zirconia-silica fibers, zirconia-silica fibers, zirconia fibers and similar refractory ceramic fibers. A suitable alumina-silica refractory ceramic fiber is commercially available from Unifrax I LLC (Tonawanda, N.Y., USA) under the registered trademark FIBERFRAX. The FIBERFRAX refractory ceramic fibers comprise the fiberization product of about 45 to about 75 weight percent alumina and about 25 to about 55 weight percent silica. The FIBERFRAX refractory ceramic fibers are able to withstand operating temperatures up to about 1540° C. and a melting point up to about 1870° C. The FIBERFRAX fibers are easily formed into high temperature resistant sheets and papers.

According to certain embodiments, the alumina-silica fiber may comprise from about 40 weight percent to about 60 weight percent Al₂O₃ and about 60 weight percent to about 40 weight percent SiO₂. According to other illustrative embodiments, the alumina-silica fiber may comprise about 50 weight percent Al₂O₃ and about 50 weight percent SiO₂.

The alumina-silica-magnesia glass fiber may comprise from about 64 weight percent to about 66 weight percent SiO₂, from about 24 weight percent to about 25 weight percent Al₂O₃, and from about 9 weight percent to about 10 weight percent MgO.

In certain embodiments, the glass fibers may comprise the fiberization product of about 63 to about 67 weight percent SiO2, about 3 to about 5 weight percent Al2O3, about 4 to about 7 weight percent CaO, about 2 to about 4 weight percent MgO, about 4 to about 7 weight percent B2O3, about 14 to about 17 weight percent Na2O, greater than 0 to about 2 weight percent K2O, greater than 0 to about 1 weight percent ZnO, greater than 0 to about 1 weight percent Fe2O3, greater than 0 to about 1 weight percent BaO, and greater than 0 to about 1 weight percent F2.

Exemplary glass fiber compositions are set forth in the table below:

Glass Fiber Compositions (% by weight)

| | Glass A | Glass B | Glass C | Glass E |
|---|---|---|---|---|
| SiO₂ | 68.0-71.0 | 55.0-60.0 | 63.0-67.0 | 50.0-56.0 |
| Al₂O₃ | 2.5-4.0 | 4.0-7.0 | 3.0-5.0 | 13.0-16.0 |
| B₂O₃ | <0.09* | 8.0-11.0 | 4.0-7.0 | 5.8-10.0 |
| Na₂O | 10.5-12.0 | 9.5-13.5 | 14.0-17.0 | <0.50 |
| K₂O | 4.5-6.0 | 1.8-4.0 | <2.0 | <0.40 |
| CaO | 5.0-7.0 | 2.8-5.0 | 4.0-7.0 | 15.0-24.0 |
| MgO | 2.0-4.0 | <2.0 | 2.0-4.0 | <5.5 |
| Fe₂O₃ | <0.20 | <0.20 | <0.20 | <0.50 |
| ZnO | <2.0 | 2.0-5.0 | <0.10 | <0.02 |
| BaO | — | 3.0-6.0 | <0.10 | <0.03 |
| F₂ | — | <1.0 | <1.0 | <1.0 |
| TiO₂ | — | — | — | <1.0 |

*B₂O₃ contains 31.1% boron by weight. The maximum allowable boron content in A-Glass is 0.028%.

The E-glass fiber typically comprises from about 52 weight percent to about 56 weight percent SiO₂, from about 16 weight percent to about 25 weight percent CaO, from about 12 weight percent to about 16 weigh percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

Without limitation, suitable examples of alkaline earth silicate fibers that can be used to prepare the fiber paper support layer for the inorganic platelets include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

According to certain embodiments, the alkaline earth silicate fibers may comprise the fiberization product of a mixture of oxides of magnesia and silics. These fibers are commonly referred to as magnesium-silicate fibers. The magnesium-silicate fibers generally comprise the fiberization production of about 60 to about 90 weight percent silica, from greater than 0 to about 35 weight percent magnesia and 5 weight percent or less impurities. According to certain embodiments, the magnesium-silicate fibers comprise the fiberization product of about 65 to about 86 weight percent silica, about 14 to about 35 weight percent magnesia and 5 weight percent or less impurities. According to other embodiments, the magnesium-silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Niagara Falls, N.Y.) under the registered trademark ISOFRAX. Commercially available ISOFRAX fibers generally comprise the fiberization product of about 70 to about 80 weight percent silica, about 18 to about 27 weight percent magnesia and 4 weight percent or less impurities.

According to certain embodiments, the alkaline earth silicate fibers may comprise the fiberization product of a mixture of oxides of calcium, magnesium and silica. These fibers are commonly referred to as calcia-magnesia-silica fibers. According to certain embodiments, the calcia-magnesia-silica fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silica fibers are commercially available from Unifrax I LLC (Niagara Falls, N.Y.) under the registered trademark INSULFRAX. INSULFRAX fibers generally comprise the fiberization product of about 61 to about 67 weight percent silica, from about 27 to about 33 weight percent calcia, and from about 2 to about 7 weight percent magnesia. Other suitable calcia-magnesia-silica fibers are commercially available from Thermal Ceramics (Augusta, Ga.) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amount of magnesia, alumina and iron oxide.

Suitable silica fibers used in the production of the fiber paper support layer for inorganic platelets include those leached glass fibers available from BelChem Fiber Materials GmbH, Germany, under the trademark BELCOTEX, from Hitco Carbon Composites, Inc. of Gardena Calif., under the registered trademark REFRASIL, and from Polotsk-Steklovolokno, Republic of Belarus, under the designation PS-23(R).

The BELCOTEX fibers are standard type, staple fiber pre-yarns. These fibers have an average fineness of about 550 tex and are generally made from silicic acid modified by alumina. The BELCOTEX fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL fibers, like the BELCOTEX fibers, are amorphous leached glass fibers high in silica content for providing thermal insulation for applications in the 100° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23(R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL fibers, have a melting point of about 1700° C.

The binder that may be included in fiber paper may comprise an organic binder selected from acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, unsaturated polyesters, expoxy resins, polyvinyl esters and combinations thereof. According to other embodiments, the binder included in the inorganic fiber paper may comprise an inorganic binder. The inorganic binder may be selected from colloidal alumina, colloidal silica, colloidal zirconia and combinations thereof. The binder may include a blend of organic binder and inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder.

The one or more support layer(s) may comprise a woven fabric. The fibers of the woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers, aramid fibers and combinations thereof. According to other embodiments, the woven fabric is coated or impregnated with a coating composition.

The one or more support layer(s) may comprise a non-woven fabric. The fibers of the woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers, aramid fibers and combinations thereof. The non-woven fabric may be consolidated by a suitable method such as, for example, hydroentangling, needling, or thermal bonding techniques.

In certain embodiments, the inorganic platelet composition/layer is directly or indirectly coated onto the support layer, applied to the support layer and permitted to impregnate or saturate into the thickness of the support layer, or impregnated into and coated onto the support layer. By indirectly coating, it is meant that the inorganic platelet layer may be coated onto a carrier layer, and the carrier layer engaged with the support layer with the inorganic layer disposed between the carrier layer and the support layer. The carrier layer can then be removed leaving a multiple layer composite comprising the inorganic platelet layer on the support layer.

The inorganic platelet composition may be directly applied to a support layer, for example, without limitation, by roll or reverse roll coating, gravure or reverse gravure coating, transfer coating, spray coating, brush coating, dip coating, tape casting, doctor blading, slot-die coating, deposition coating, dipping, or by immersion. In certain embodiments, the inorganic platelet composition is applied to the support layer as a slurry of the ingredients in a solvent, such as water, and is allowed to dry. The inorganic platelet composition may be created as a signal layer or coating on the support layer, thus utilizing a single pass, or may be created by utilizing multiple passes, layers or coatings. By utilizing multiple passes, the potential for formation of defects in the inorganic platelet layer is reduced. If multiple passes are desired, the second and possible subsequent passes may be formed onto the first pass while the first pass is still substantially wet, i.e. prior to drying, such that the first and subsequent passes are able to form a single unitary layer upon drying.

The inorganic platelet composition may include a wide variety of functional fillers. For example, and without limitation, the inorganic platelet composition may further include heat resistant insulating fibers, endothermic materials, flame retardants and combinations thereof.

The inorganic platelet composition may further include a flame retardant. The flame retardant material may be selected from any material that delays, inhibits, or slows the spread of fire by suppressing chemical reactions. According to certain embodiments, the flame retardant may comprise antimony compounds, magnesium hydroxide, aluminum hydroxides, aluminum trihydrate, aluminum oxide hydrate, boron compound such as borates, carbonates, bicarbonates, inorganic halides, sulfates, organic halogens, organic phosphorous compounds and combinations thereof. Suitable antimony compounds include, without limitation, antimony trioxide, antimony pentoxide and sodium animonate. Organic halogens include, for example, organobromines and organic chlorines. Suitable organobromines include, without limitation, decabromodiphenyl ether and decabromodiphenyl ethane. Suitable organobromines include polymeric brominated compounds such as brominated polystyrenes, brominated carbonate oligomers, brominated epoxy oligomers, tetrabromophthalic anhydride, tetrabromobisphenol A, and hexabromocyclododecane. Suitable organochlorines include, without limitation, derivatives of chlorenic acid and chlorinated paraffins. Suitable organophosphorus compounds include, without limitations, triphenyl phosphate, resorcinol bis(disphenylphoshate), bisphenol diphenyl phosphate, tricresyl phosphate, triarylphosphates, ammonium pholyphosphate, trischloropropyl phosphate, red phosphorous, and phosphonates. Suitable phosphonates include, without limitation, dimethyl methylphosphonate, aluminum diethyl phosphonate, and metal phosphonates.

In certain embodiments, the inorganic platelet composition, coating, an inorganic platelet composition composite or laminate material, and/or a composite or laminate material including the inorganic platelet composition, may include at least one of the following: (i) at least one material that alters the electrical properties of the composition, coating, composite or laminate, such as an electrical insulation composition or material; (ii) a material which alters the heat transfer coefficient of the composition, coating, composite or laminate, such as a material which dissipates heat; (iii) a material which provides moisture resistance to the composition, coating, composite or laminate; (iv) an endothermic material; or (v) any other material which may conventionally be used in thermal/electrical insulation, such as for batteries.

The electrochemical battery module includes a plurality of individual electrochemical battery cells, such as lithium ion cells, that are electrically connected together in series or parallel. Battery modules of electrically connected individual cells may be electrically connected to another battery module to form a battery pack. Each of the individual electrochemical battery cells of the battery module or pack includes an outer housing, an anode, a cathode, a separator separating said anode from said cathode and an electrolyte. According to certain illustrative embodiments, the geometry of outer housing of the battery cell is cylindrical. It is to be noted, however, that there is no limitation to the geometry of the outer housing of the battery cell. The individual battery cells are electrically connected and arranged in close proximity, or in near adjacent contact, to one another to form a module of individual cells. When the individual battery cells are arranged in adjacent or near adjacent contact with one another, there are gaps or open air spaces created between the individual cells resulting from the geometry of the outer housing of the cells. These gaps or open air spaces between the individual cells are referred to in the battery pack art as “interstitial spaces”.

To mitigate the propagation of a thermal runaway event originating in an individual battery or battery module, a thermal and electrical insulation barrier comprising an inorganic platelet material is located within at least a portion of the interstitial spaces between said individual battery cells of said lithium ion battery module, and/or applied to, coated, or deposited onto the outer surfaces of the individual battery cells, and/or placed on at least a portion of the interior and/or exterior surfaces of a housing of a battery module or pack. The inorganic platelet compositions described herein may also and/or alternatively be used for electrical insulation purposed associated with battery cells, modules or packs, such as to prevent arcing between adjacent cells and/or between battery cells and housings and electrical short circuits. A fluid dispersion or slurry of the inorganic platelet composition may be introduced into the interstitial spaces between the outer surfaces of neighboring battery cells by coating or depositing the inorganic platelet composition onto the outer surfaces of the individual battery cells, and/or injecting the inorganic platelet composition into the interstitial spaces between the individual cells.

Instead of applying the thermal insulation to the housing and/or interstitial spaces between the individual cells of the battery module or battery pack in the form of a fluid coating composition, the inorganic platelet composition may be formed into continuous or discontinuous felts, films, papers, shapes, or sheets that can be positioned on at least a portion of a surface of a housing of the battery module or pack, and/or in the interstitial spaces between the cells of the module or packs to separate neighboring cells or modules from one another. According to certain embodiments, the outer surface of the adjacent or neighboring battery cells may be wrapped with a suitable amount of the inorganic platelet films and/or sheets. According to other illustrative embodiments, sheets of the inorganic platelets may be positioned in the interstitial spaces between columns or rows of adjacently positioned individual cells. According to yet further illustrative embodiments, a suitable length of continuous films or sheets of inorganic platelet material may be positioned in the interstitial spaces of adjacent battery cells within a single column or row of adjacent cells in a repeated S-shaped pattern.

According to certain embodiments, films, felts, papers, or sheets of the inorganic platelet composition may be positioned in the interstitial spaces between columns and/or rows of adjacently positioned individual cells and adjacent to or in direct contact with the interior wall surfaces of a battery module or battery pack.

According to certain embodiments, the exterior surfaces of individual battery cells with a battery module or battery pack may be wrapped with films, felts, papers, or sheets of the inorganic platelet composition, and such films, felts, papers, or sheets of the inorganic platelet composition may be positioned adjacent to or in direct contact with the interior wall surfaces of a battery module or battery pack.

According to certain embodiments, the exterior surfaces of individual battery cells with a battery module or battery pack may be wrapped with films, felts, papers, or sheets of the inorganic platelet composition, and such films, felts, papers, or sheets of the inorganic platelet composition may be positioned within interstitial spaced between battery cells and positioned adjacent to or in direct contact with the interior wall surfaces of a battery module or battery pack.

According to certain embodiments, films, felts, papers, or sheets of the inorganic platelet composition may be positioned in the interstitial spaces between columns or rows of adjacently positioned individual cells, and a fluid composition of the inorganic platelet composition applied to the interior wall surfaces of a battery module or battery pack.

According to certain embodiments, the exterior surfaces of individual battery cells with a battery module or battery pack may be wrapped with films, felts, papers, or sheets of the inorganic platelet composition, and a fluid composition of the inorganic platelet composition applied to the interior wall surfaces of a battery module or battery pack.

According to certain embodiments, the exterior surfaces of individual battery cells with a battery module or battery pack may be wrapped with films, felts, papers, or sheets of the inorganic platelet composition, and such films, felts, papers, or sheets of the inorganic platelet composition may be positioned within interstitial spaced between battery cells, and a fluid composition of the inorganic platelet composition applied to the interior wall surfaces of a battery module or battery pack.

According to certain embodiments, a fluid composition of the inorganic platelet composition may be applied to the exterior surfaces of individual battery cells with a battery module or battery pack, and applied to the interior wall surfaces of a battery module or battery pack.

According to certain embodiments, a fluid composition of the inorganic platelet composition may be applied to the exterior surfaces of individual battery cells with a battery module or battery pack, applied within the interstitial spaced between adjacent individual battery cells, and applied to the interior wall surfaces of a battery module or battery pack.

According to certain illustrative embodiments, a thermally insulating potting compound or material may be applied to the battery modules or battery packs after the thermally insulating inorganic platelet composition has been applied to the interstitial spaces between the individual battery cells.

The housings of the battery modules and packs may be comprised of metals, metal alloys, rigid polymeric materials, fiber reinforced polymeric materials, composite materials, and the like.

The battery modules and battery packs comprising a plurality of electrochemical cells may be utilized in an all-electric vehicles (EVs), a plug-in hybrid vehicles (PHEVs), or a hybrid vehicle (HEV). The electric vehicle generally comprises a structural frame, a passenger cabin, an electric drive motor, a motor controller to control the electric drive motor, braking system and electrochemical battery pack for providing power to the drive motor(s). According to certain illustrative embodiments, the battery pack is mounted between the passenger cabin floor panel of an electric vehicle and the driving surface. A thermal insulation barrier comprising an inorganic platelet material is interposed between the battery pack enclosure and the passenger cabin floor panel.

Product forms comprising the inorganic platelet composition possess a variety of advantageous material properties making them suitable for thermal and electrical insulation and fire protection for electrochemical battery module and pack to prevent thermal runaway and electrical short circuiting. These material properties include one or more of the following:

The material has typical thicknesses of about 0.1to about 0.5 mm;

The materials has typical basis weights in the range of about 100 to about 200 g/m2;

The material is resistant to temperatures of 1000 C. and greater;

The material has a dielectric strength as measured by ASTM D149 of about 450 to about 700 V/mil;

The material possesses a burst strength of greater than 300 kPa;

The material has a puncture resistance (tested with 10 mm probe) of greater than 50 N;

The material exhibits a permeance of greater than 0.2 perms.

In a first embodiment, provided is an electrochemical battery module or pack comprising a housing having an interior surface and an exterior surface, at least one electrochemical battery cell positioned within said housing, and one or more of the following: (i) an inorganic platelet composition positioned adjacent to or on at least a portion of said interior surface of said housing; (ii) an inorganic platelet composition positioned adjacent to or on at least a portion of said exterior surface of said housing; (iii) wherein said electrochemical battery module comprises a plurality of said electrochemical battery cells, and wherein an inorganic platelet composition is on said electrochemical battery cells; or (iv) wherein said electrochemical battery module comprises a plurality of said electrochemical battery cells, having interstitial spaces between said plurality of said electrochemical battery cells, and wherein an inorganic platelet composition is located within at least a portion of said interstitial spaces between said electrochemical battery cells.

The electrochemical battery module or pack of the first embodiment may include that said individual electrochemical battery cells comprises lithium ion cells.

The electrochemical battery module or pack of either of the first or subsequent embodiments include that said inorganic platelet composition comprises a coating applied to at least a portion of said lithium ion cells in the interstitial spaces between said lithium ion cells.

The electrochemical battery module or pack of any of the first or subsequent embodiments may include that said inorganic platelet composition comprises a sheet applied to at least a portion of said lithium ion cells in the interstitial spaces between said lithium ion cells. Said inorganic platelet composition sheet may comprise a composite comprising a support layer and an inorganic platelet composition layer. Said support layer may comprise a polymer film, a paper, a woven fabric or combinations thereof. Said polymer film may be selected from polyester, polyimide, polyetherketone, polyetheretherketone, polyvinylfluoride, polyamide, polytetrafluorotheylene, polyaryl sulfone, polyester amide, polyester imide, polyethersulfone, polyphenylene sulfide, ethylene chlorotrifluoroethylene films and combinations thereof. Said polymer film may comprise a polyetheretherketone film. Said support layer may comprises an inorganic fiber paper. Said inorganic fibers may be selected from the group consisting of polycrystalline wool fibers, refractory ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, silica fibers and combinations of one or more of these types of inorganic fibers. Said inorganic fibers may comprise refractory ceramic fibers comprising the fiberization product of about 45 to about 75 weight percent alumina and about 25 to about 55 weight percent silica. Said inorganic fibers may comprise alkaline earth silicate fibers. Said alkaline earth silicate fibers may comprise the fiberization product of about 60 to about 90 weight percent silica, from greater than 0 to about 35 weight percent magnesia and 5 weight percent or less impurities. Said alkaline earth silicate fibers may comprise the fiberization product of about 45 to about 90 weight percent silica, from greater than 0 to about 45 weight percent calcia, from greater than 0 to about 35 weight percent magnesia, and 10 weight percent or less impurities. Said alkaline earth silicate fibers may comprise the fiberization product of calcia and silica. Said inorganic fibers may comprise calcia-alumina fibers comprising from about 20 to about 80 weight percent calcia and from about 80 to about 20 weight percent alumina. Said inorganic fibers may comprise silica fibers comprising 90 weight percent or greater silica. Said inorganic fibers may comprise alumina fibers comprising 90 weight percent or greater alumina. Said support layer may comprise a woven fabric.

The electrochemical battery module or pack of any of the first or subsequent embodiments may include that said inorganic platelet composition comprises and inorganic platelets selected from vermiculite, mica, clay, tale platelets and combinations thereof. Said inorganic platelets may have a diameter of from about 20 μm to about 300 μm. Said inorganic platelets may have a diameter of from about 40 μm to about 200 μm. Said inorganic platelets may have an aspect ratio of from about 50:1 to about 2000:1. Said inorganic platelets may have an aspect ratio of from about 50:1 to about 1000:1. Said inorganic platelets may have an aspect ratio of from about 200:1 to about 800:1. Said inorganic platelet composition may comprise inorganic platelets in an amount from about 20 to about 100 weight percent. Said inorganic platelet composition may comprise inorganic platelets in an amount of at least 20 weight percent. Said inorganic platelet composition may comprise inorganic platelets in an amount of at least 30 weight percent. Said inorganic platelet composition may comprise inorganic platelets in an amount of at least 40 weight percent. Said inorganic platelet composition may comprise inorganic platelets in an amount of at least 50 weight percent. Said inorganic platelet composition may comprise inorganic platelets in an amount of at least 60 weight percent. Said inorganic platelet composition may comprise inorganic platelets in an amount of at least 70 weight percent. Said inorganic platelet composition may comprise inorganic platelets in an amount of at least 80 weight percent. Said inorganic platelet composition may comprise inorganic platelets in an amount of at least 85 weight percent. Said inorganic platelet composition may comprise inorganic platelets in an amount of at least 90 weight percent. Said inorganic platelet composition may comprise inorganic platelets in an amount of at least 95 weight percent. Said inorganic platelet composition may comprise inorganic platelets in an amount of at least 99 weight percent. Said inorganic platelet composition may comprise inorganic platelets in an amount of at least 100 weight percent. Said inorganic platelet composition may comprise vermiculite platelets in an amount of at least 20 weight percent. Said inorganic platelet composition may comprise vermiculite platelets in an amount of at least 30 weight percent. Said inorganic platelet composition may comprise vermiculite platelets in an amount of at least 40 weight percent. Said inorganic platelet composition may comprise vermiculite platelets in an amount of at least 50 weight percent. Said inorganic platelet composition may comprise vermiculite platelets in an amount of at least 60 weight percent. Said inorganic platelet composition may comprise vermiculite platelets in an amount of at least 70 weight percent. Said inorganic platelet composition may comprise vermiculite platelets in an amount of at least 80 weight percent. Said inorganic platelet composition may comprise vermiculite platelets in an amount of at least 85 weight percent. Said inorganic platelet composition may comprise vermiculite platelets in an amount of at least 90 weight percent. Said inorganic platelet composition may comprise vermiculite platelets in an amount of at least 95 weight percent. Said inorganic platelet composition may comprise vermiculite platelets in an amount of at least 99 weight percent. Said inorganic platelet composition may comprise vermiculite platelets in an amount of at least 100 weight percent. Said inorganic platelet composition may comprise from about 20 to about 100 percent by weight of vermiculite platelets and from 0 to about 80 percent by weight of binder. Said inorganic platelet composition may comprise from about 30 to about 100 percent by weight of vermiculite platelets and from 0 to about 70 percent by weight of binder. Said inorganic platelet composition may comprise from about 40 to about 100 percent by weight of vermiculite platelets and from 0 to about 60 percent by weight of binder. Said inorganic platelet composition may comprise from about 50 to about 100 percent by weight of vermiculite platelets and from 0 to about 50 percent by weight of binder. Said inorganic platelet composition may comprise from about 60 to about 100 percent by weight of vermiculite platelets and from 0 to about 40 percent by weight of binder. Said inorganic platelet composition may comprise from about 70 to about 100 percent by weight of vermiculite platelets and from 0 to about 30 percent by weight of binder. Said inorganic platelet composition may comprise from about 80 to about 100 percent by weight of vermiculite platelets and from 0 to about 20 percent by weight of binder. Said inorganic platelet composition may comprise from about 20 to about 100 percent by weight of vermiculite platelets, from 0 to about 40 percent by weight of binder, and from 0 to about 50 percent by weight of a functional filler. Said inorganic platelet composition may comprise from about 50 to about 100 percent by weight of vermiculite platelets, from 0 to about 30 percent by weight of binder, and from 0 to about 20 percent by weight of a functional filler. Said inorganic platelet composition may comprise from about 60 to about 100 percent by weight of said vermiculite platelets, from 0 to about 20 percent weight of a binder, and from 0 to about 20 percent by weight of a functional filler.

In a second embodiment, provided is an automobile battery comprising a housing and at least one electrochemical battery module or pack according to any one of the first or subsequent embodiments.

In a third embodiment, provided is an electric vehicle comprising: a structural frame; a passenger cabin; an electric drive motor; a motor controller, braking system; and a battery comprising at least one electrochemical battery module or pack according to any one of the first or subsequent embodiments.

In a fourth embodiment, provided is an aircraft battery comprising at least one electrochemical battery module or pack according to any one of the first or subsequent embodiments.

In a fifth embodiment, provided is a lithium ion battery module or pack comprising: a housing and a plurality of individual lithium ion cells electrically connected together, each of said lithium ion cells comprising an outer housing, an anode, a cathode, a separator separating said anode from said cathode and an electrolyte, said lithium ion battery module comprising interstitial spaces between the individual lithium ion cells; and an inorganic platelet composition located within at least a portion of said interstitial spaces between said individual lithium ion battery cells of said lithium ion battery module.

In a sixth embodiment, provided is lithium ion battery pack comprising: a housing and a plurality of individual lithium ion cells electrically connected together, each of said lithium ion cells comprising an outer housing, an anode, a cathode, a separator separating said anode from said cathode and an electrolyte said lithium ion battery module comprising interstitial spaces between the individual lithium ion cells; and an inorganic platelet composition located within at least a portion of said interstitial spaces between said individual lithium ion battery cells of said lithium ion battery module.

In a seventh embodiment, provided is an automobile battery comprising: a housing and a plurality of individual lithium ion cells electrically connected together, each of said lithium ion cells comprising an outer hosing, an anode, a cathode, a separator separating said anode from said cathode and an electrolyte, said lithium ion battery module comprising interstitial spaces between the individual lithium ion cells; and an inorganic platelet composition located within at least a portion of said interstitial spaces between said individual lithium ion battery cells of said lithium ion battery module.

In a eighth embodiment, provided is an electric vehicle comprising: a structural frame; a passenger cabin; an electric drive motor; a motor controller; braking system; and an electrochemical battery pack mounted below said passenger cabin, said electrochemical battery pack comprising a housing and a plurality of individual battery cells electrically connected together and having interstitial spaces between the individual battery cells, and an inorganic platelet composition located within at least a portion of said interstitial spaces between said individual battery cells of said battery pack.

In a ninth embodiment, provided is an aircraft battery comprising: a housing and a plurality of individual lithium ion cells electrically connected together, each of said lithium ion cells comprising an outer housing, an anode, a cathode, a separator separating said anode from said cathode and an electrolyte, said lithium ion battery module comprising interstitial spaces between the individual lithium ion cells; and an inorganic platelet composition located within at least a portion of said interstitial spaces between said individual lithium ion battery cells of said lithium ion battery module.

While the electrochemical battery module and packs have been described in connection with various embodiments, it is to be understood that other similar embodiments may be used or modifications and additions may be made to the described embodiments for performing the same function. Furthermore, the various illustrative embodiments may be combined to produce the desired results. The disclosure should not be limited to any single embodiment, but rather construed in breadth and scope in accordance with the reaction of the appended claims. it will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. An electrochemical battery module comprising a housing having an interior surface and an exterior surface, at least one electrochemical battery cell positioned within said housing, and one or more of the following:
(i) an inorganic platelet composition positioned adjacent to or on at least a portion of said interior surface of said housing;
(ii) an inorganic platelet composition positioned adjacent to or on at least a portion of said exterior surface of said housing;
(iii) wherein said electrochemical battery module comprises a plurality of said electrochemical battery cells, and wherein an inorganic platelet composition is on said electrochemical battery cells; or
(iv) wherein said electrochemical battery module comprises a plurality of said electrochemical battery cells, having interstitial spaces between said plurality of said electrochemical battery cells, and wherein an inorganic platelet composition is located within at least a portion of said interstitial spaces between said electrochemical battery cells.

2. The electrochemical battery module of claim 1, wherein said inorganic platelet composition is positioned adjacent to or on at least a portion of said interior surface of said housing.

3. The electrochemical battery module of claim 1, wherein said inorganic platelet composition is positioned adjacent to or on at least a portion of said exterior surface of said housing.

4. The electrochemical battery module of claim 1, wherein said electrochemical battery module comprises a plurality of said electrochemical battery cells, and said inorganic platelet composition is applied on said electrochemical battery cells.

5. The electrochemical battery module of claim 1, wherein said electrochemical battery module comprises a plurality of said electrochemical battery cells having interstitial spaces between the plurality of said electrochemical battery cells, and wherein said inorganic platelet composition is located within at least a portion of said interstitial spaces between said electrochemical battery cells.

6. The electrochemical battery module of claim 1, wherein said at least one electrochemical battery cell comprises at least one lithium ion cell.

7. The electrochemical battery module of claim 6, wherein said inorganic platelet composition comprises a coating applied in at least a portion of said interstitial spaces between said lithium ion cells.

8. The electrochemical battery module of claim 6, wherein said inorganic platelet composition comprises a sheet applied in at least a portion of said interstitial spaces between said lithium ion cells.

9. The electrochemical battery module of claim 8, wherein said sheet comprises a composite sheet comprises a support layer and an inorganic platelet composition layer.

10. The electrochemical battery module of claim 9, wherein said support layer comprises a polymer film, a paper, a non-woven fabric, a woven fabric, or combinations thereof.

11. The electrochemical battery module of claim 10, wherein said support layer comprises a polymer film selected from polyester, polyimide, polyetherketone, polyetheretherketone, polyvinylfluoride, polyamide, polytetrafluorotheylene, polyaryl sulfone, polyester amide, polyester imide, polyethersulfone, polyphenylene sulfide, ethylene chlorotrifluoroethylene films and combinations thereof.

12. The electrochemical battery module of claim 10, wherein said support layer comprises a paper.

13. The electrochemical battery module of claim 12, wherein said paper comprises an inorganic fiber paper comprising inorganic fibers selected from the group consisting of polycrystalline wool fibers, refractory ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, silica fibers and combinations of one or more of these types of inorganic fibers.

14. The electrochemical battery module of claim 10, wherein said support layer comprises a woven fabric.

15. The electrochemical battery module of claim 10, wherein said support layer comprises a non-woven fabric.

16. The electrochemical battery module of claim 1, wherein said inorganic platelet composition comprises inorganic platelets selected from vermiculite, mica, clay, tale platelets and combinations thereof.

17. The electrochemical battery module of claim 16, wherein said mica platelets have a diameter of from about 20 μm to about 30 μm.

18. The electrochemical battery module of claim 16, wherein said inorganic platelet composition comprises mica platelets in an amount from about 20 to about 100 weight percent.

19. The electrochemical battery module of claim 16, wherein said inorganic platelet composition comprises mica platelets in an amount of at least 20 percent.

20. The electrochemical battery module of claim 16, wherein said inorganic platelet composition comprises from about 20 to less than about 100 percent by weight of mica platelets and from greater than 0 to about 80 percent by weight of binder.

21. The electrochemical battery module of claim 16, wherein said inorganic platelet composition comprises from about 20 to less than about 100 percent by weight of mica platelets, from greater than 0 to about 40 percent by weight of binder, and from greater than 0 to about 50 percent by weight of a functional filler.

22. A lithium ion battery pack comprising:
a housing having an interior surface and an exterior surface;
a plurality of individual lithium ion cells within said housing and electrically connected together, each of said lithium ion cells comprising an outer housing, an anode, a cathode, a separator separating said anode from said cathode and an electrolyte, said lithium ion battery pack comprising interstitial spaces between the individual lithium ion cells; and
an inorganic platelet composition (i) located or positioned on the exterior surfaces of at least a portion of the individual lithium ion cells positioned within said housing, and/or (ii) within at least a portion of said interstitial spaces between said individual lithium ion cells positioned within said housing of said electrochemical battery pack, and/or (iii) adjacent to or on at least a portion of the internal surfaces of the housing of the lithium ion battery pack, and/or (iv) adjacent to or on at least a portion of the external surfaces of the housing of the lithium ion battery pack.

23. An automobile battery comprising the lithium ion battery pack of claim 23.

24. An aircraft battery comprising the lithium ion battery pack of claim 23.

25. An electric hybrid electric vehicle comprising:
a structural frame;
a passenger cabin;
an electric drive motor;
a motor controller;
braking system; and
electrochemical battery pack mounted below said passenger cabin, said electrochemical battery pack comprising a housing having internal surfaces and external surfaces, a plurality of individual battery cells electrically connected together, having interstitial spaces between the individual battery cells and being at least partially positioned within said housing and an inorganic platelet composition (i) located or positioned on the exterior surfaces of at least a portion of the individual electrochemical cells positioned within said housing, and/or (ii) within at least a portion of said interstitial spaces between said individual electrochemical battery cells positioned within said housing of said electrochemical battery pack, and/or (iii) adjacent to or on at least a portion of the internal surfaces of the housing of the electrochemical battery pack, and/or (iv) adjacent to or on at least a portion of the external surfaces of the housing of the electrochemical battery pack.
